(19) United States
(12) Patent Application Publication
(10) Pub. No.: US 2024/0323163 A1
(43) Pub. Date: Sep. 26, 2024

(54) SYSTEMS AND METHODS FOR SECURE COMMUNICATIONS

(71) Applicant: Crowley Government Services, Inc., Jacksonville, FL (US)

(72) Inventors: Dirk Edward Goehring, Jacksonville, FL (US); Dustin Lee Durbin, Jacksonville, FL (US); Mark Janisch, Jacksonville, FL (US)

(21) Appl. No.: 18/615,940

(22) Filed: Mar. 25, 2024

Related U.S. Application Data
(60) Provisional application No. 63/454,424, filed on Mar. 24, 2023.

(51) Int. Cl. H04L 9/40

(52) U.S. Cl. CPC H04L 63/0209; H04L 63/0428; H04L 63/1441

(57) ABSTRACT

Systems, methods, and computer-readable storage media for secure communications, and more specifically to securing communications on previously air-gapped equipment using post-quantum encryption. A system can include: a first technology environment comprising at least one first technology component, the at least one first technology component comprising a first Post-Quantum Encryption (PQE) module; a second technology environment comprising at least one second technology component, the at least one second technology component comprising a second PQE module; a demilitarized zone (DMZ) environment having at least one DMZ processor; and a communications network, where the first technology environment, the second technology environment, and the DMZ environment are networked together across the communications network such that communications between the first technology environment and the second technology environment pass through the DMZ environment, the communications being encrypted using PQE.

### CROSS REFERENCE TO RELATED APPLICATIONS

The present application claims priority to U.S. provisional patent application No. 63/454,424 filed Mar. 24, 2023, the entire content of which is hereby incorporated by reference in its entirety.

### BACKGROUND

### 1. Technical Field

The present disclosure relates to secure communications, and more specifically to securing communications on Operational Technology (OT) and/or Informational Technology (IT) equipment using Post-Quantum Encryption (PQE).

### 2. Introduction

Providing secure communication across network boundaries allows for rapid response to changing situations and leads to better decision-making.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: receiving, at a first PQE (Post Quantum Encryption) module embedded within a first technology component, first data from the first technology component, the first data having been analyzed for at least one of malicious and unauthorized activity; formatting the first data, resulting in formatted first data; encrypting the formatted first data using PQE, resulting in encrypted data; and transmitting the encrypted data from the first PQE module to a second PQE module via a communications network, wherein the encrypted data is further analyzed by at least one DMZ processor within a DMZ environment before arriving at the second PQE module.

A system configured to perform the concepts disclosed herein can include: a first technology environment comprising at least one first technology component, the at least one first technology component comprising a first Post-Quantum Encryption (PQE) module; a second technology environment separated from the first technology environment by a communications network, the second technology environment comprising at least one second technology component, the at least one second technology component comprising a second PQE module; and a demilitarized zone (DMZ) environment having at least one DMZ processor, wherein the first technology environment, the second technology environment, and the DMZ environment are networked together across the communications network such that communications between the first technology environment and the second technology environment pass through the DMZ environment; and wherein the first PQE module and the second PQE module each perform at least one of transmitting and receiving of the communications between the first technology environment and the second technology environment, the communications being encrypted using PQE algorithms.

A non-transitory computer-readable storage medium configured as disclosed herein can have instructions stored which, when executed by at least one processor, cause the at least one processor to perform operations which include: receiving, at a first PQE (Post Quantum Encryption) module embedded within a first technology component, first data from the first technology component, the first data having been analyzed for at least one of malicious and unauthorized activity; formatting the first authorized data, resulting in formatted first data; encrypting the formatted first data using PQE, resulting in encrypted data; and transmitting the encrypted data from the first PQE module to a second PQE module via a communications network, wherein the encrypted data is further analyzed by at least one DMZ processor within a DMZ environment before arriving at the second PQE module.

### BRIEF DESCRIPTION OF THE DRAWINGS

FIG. 1 illustrates an example of a Purdue reference architecture model;

FIG. 2 illustrates an example of a hybrid Purdue reference architecture;

FIG. 3 illustrates an example of an enterprise architecture that incorporates a cloud-based operational technology DMZ;

FIG. 4 illustrates an example of a modular component which can be added to operational technology to enable secure communications;

FIG. 5 illustrates an example of data flow for a deployed component module;

FIG. 6 illustrates an example method embodiment; and

FIG. 7 illustrates an example computer system.

### DETAILED DESCRIPTION

Various embodiments of the disclosure are described in detail below. While specific implementations are described, this is done for illustration purposes only. Other components and configurations may be used without parting from the spirit and scope of the disclosure.

Data produced within Operational Technology (OT) environments have high value to the business. OT environments and systems have traditionally been “air-gapped” as a means of isolation from other networks or external connectivity. As a result, the organization may have limited (if any) networked communication with the OT devices, and may be unable to interact with, or gather data from the OT equipment. In some cases, all control and alerting may be on-site only. Communication within the OT environment may use legacy protocols without encryption, despite including systems that are crucial for safe, efficient operation.

Non-limiting examples of OT environments and systems can include communication systems (VSAT (Very-Small-Aperture Terminal), radio, cellular), navigation systems (electronic charts, AIS (Automatic Identification System), radar), power generation and propulsion systems (engines, generators, batteries), cargo handling systems (loading, unloading, tracking), safety and security systems (fire suppression, cameras, physical access control), monitoring and control systems (for any onboard system, including pressure, temperature, vibration sensors, PLCs (Programmable Logic Controls), RTUs (Remote Terminal Units)), ballast water treatment systems (safe water discharge treatment), environmental systems (emissions, waste, sewage), auxiliary systems (HVAC (Heating, Ventilation, and Air Conditioning), boilers, refrigeration), cybersecurity systems (intrusion detection and prevention, scanning, secure communications, firewalls), network infrastructure and systems (routers, switches, wireless systems, computers), fleet management systems, automation systems and other specialized systems (LNG (Liquefied Natural Gas) fuel systems, natural gas systems, gas terminals, gas pipeline controls, etc.).

Not having networked communications with these OT environments limits visibility into conditional deviations and can provide a false sense of security. For example, third-party vendors may be given privileged access to these systems with insufficient scrutiny (e.g., for system maintenance). In many cases there are extremely sensitive, high-impact systems that have no network security controls, use clear text communications, and with no remote monitoring or alerting capabilities. Likewise, there are instances where communications to/from Information Technology (IT) environments needs to be securely monitored.

In theory, encrypting communications to/from OT/IT environments could inhibit the security risks, with the idea being that because encrypted communications are extremely difficult to compromise without cryptographic keys, neither hackers nor an Internet Service Provider (ISP) can gain access to the data. However, with quantum computing improving, the fear exists that modem encryption methodologies will be vulnerable to decryption using a quantum computer without knowledge of the cryptographic key. Post-quantum encryption (PQE) refers to methods to encrypt data in a manner which is resistant to quantum cracking. For example, PQE introduces an additional key, or “PQE” key, to add resistance to quantum computer powered attacks.

Systems configured as disclosed herein can provide improved security for communications across network boundaries (e.g., IT, OT, or other networks) by including a hardware-agnostic module capable of providing end-to-end secure communications utilizing PQE. This “PQE module” can, for example, be inserted (or, if a software solution, uploaded) into previously air-gapped environments. Once the PQE module is inserted into the equipment (e.g., OT and/or IT equipment), the PQE module can (1) perform encryption/decryption of data using PQE protocols, and (2) perform local data analysis and review (i.e., via one or more processors of the module and/or equipment) of all data being transmitted and received at the updated, now networked equipment (in some configurations the now networked equipment may have been previously air-gapped, whereas in other configurations the now networked equipment may have been connected to a network using non-PQE methods). As defined herein, “local” and “remote” systems, equipment, environments, etc., are separated by a communications network, such that data must traverse the network to enable communications between local and remote systems.

The PQE module can be configured to work with communication modules on different pieces of OT equipment. For example, if the OT equipment includes a fuel pump, the PQE module can connect to the communication module of the fuel pump (e.g., via an ethernet cable, RS-232 cable, fiber-optic cable, BLUETOOTH connection, RF (Radio Frequency) connection, etc.). In this example, the PQE module can then receive the communications from the fuel pump, encrypt those communications via post-quantum encryption, and forward those PQE communications to the cloud-based DMZ for further distribution. Likewise, the PQE module can receive communications intended for the fuel pump from the cloud-based DMZ, decrypt those communications, and pass on the decrypted communications to the fuel pump. The system can use specific source and destination routing to control traffic, and can use null-routing to remove/“blackhole” undesired network traffic. The information received can vary depending on where the physical hardware is installed. The routing decisions can be made based on business needs for the data.

While the PQE module can review, analyze, and/or filter data locally at the PQE-enabled equipment, in some configurations, additional data analysis, filtering of communications, etc., can occur at a remote computing platform which is connected to the updated equipment via a network. The remote computing platform can, for example, be a cloud-based computing platform and/or a physical computing platform. The use of a remote computing platform can result in a modification to the classic reference model for Industrial Control Systems (ICS) network segmentation.

The classic reference model, the “Purdue reference architecture model,” is a model for ICS network segmentation. The Purdue reference architecture model shows the interconnections and interdependencies of all of the main components of a typical Industrial Control System (ICS), with the ICS architecture divided into two zones—Information Technology (IT) and Operational Technology (OT)—and further subdividing these zones into six levels starting at level 0. Within the Purdue reference architecture model, OT systems occupy levels 0-3, while IT systems occupy levels 4 and 5. OT and IT is separated by a demilitarized zone (DMZ), often referred to as level 3.5. The DMZ contains highly secured systems, and the communication is restricted in such a way that communication can never flow directly between levels 0-3 to/from levels 4 and 5. That is, preferably a DMZ completely segments the IT side of the architecture from the OT side using firewalls to restrict authorized communication to intermediary devices such as remote access servers, patch management servers, and application servers. The DMZ environment is a secured environment with clearly-defined boundaries and strictly-enforced ingress and egress rules. A DMZ can contain one or more computing platforms. Communication can only go between OT and the DMZ, or IT and the DMZ, and is limited to authorized communication only. Some examples of systems that may reside in the DMZ are: backup servers, data historian mirrors, remote-access servers, monitoring systems, vulnerability assessment systems, patch management systems and application servers. However, a limitation of the Purdue reference architecture model is the need for the DMZ equipment to be locally accessible to the IT/OT equipment being monitored.

Systems configured as disclosed herein can have one or more of the following improvements over the Purdue reference architecture model: (1) they can enable secure relocation of the DMZ to an offsite, or cloud-based environment, resulting in a centralized and scalable set of solutions that can manage multiple OT environments while allowing the DMZ to increase or reduce necessary computing resources as needed; (2) they can use a PQE module that encrypts network transmissions, allowing the OT components to communicate with mitigated risk of communication interception; (3) they can perform communication analysis and filtering at the OT/IT equipment, thereby preprocessing/filtering the data and reducing the bandwidth required for network communication. Non-limiting examples of technical improvements which result from use of the disclosed systems and methods include: improved communication security between OT and IT systems using PQE secure communications; scalable support for physically isolated OT facilities; centralized traffic monitoring; ability to execute predictive analytics and machine learning on the DMZ traffic; improved vulnerability and patch management; ability to backup communications to and from IT/OT components; and improved system monitoring and alerting.

As communications are received at the PQE-enabled equipment, the communications can be analyzed for malicious content (e.g., virus(es), programs, and any unauthorized software, material or data which threatens to overload, change, damage, corrupt or destroy the intended recipient device or any intermediate devices). If malicious content is detected, that content can be isolated, deleted, flagged for further review, or otherwise prohibited from being forwarded to its intended destination. When sending data, the PQE module can receive data from the OT/IT equipment, analyze the data, filter/extract portions of that data which need to be transmitted (for example, if malicious information is attempting to be transmitted, that information may be filtered out of the communication), format those remaining portions, encrypt the formatted data using PQE, then transmit the encrypted data across a network to the DMZ. Likewise, when receiving encrypted data from the DMZ, the PQE module can receive the encrypted data, decrypt it, analyze the decrypted data, filter the decrypted data as required, and then format the remaining data before sending it to the OT/IT equipment.

Systems configured as disclosed herein can also move the DMZ to the cloud, where resources can be scaled as needed, then used to further control communications between all the different environments required. For example, systems within a cloud-based DMZ can interact with local OT network infrastructure to restrict communications within or between the OT levels.

Like the local processing/filtering of communications at the PQE-enabled equipment, when communications are received at the cloud-based DMZ, those communications also can be analyzed by DMZ equipment (e.g., processors, memory, filters, firewalls, and/or other computing equipment) for malicious content (e.g., virus(es), programs, and any unauthorized software, material or data which threatens to overload, change, damage, corrupt or destroy the intended recipient device or any intermediate devices). For example, a cloud-based next-generation firewall can scan the traffic for malicious content with signature-based detection. In such cases, the DMZ can be a secured subnetwork that is logically separated from an internal private network to protect the internal private network. The DMZ functions as a buffer area between users or systems and private, confidential, sensitive, or business critical networks. An alternative approach to the DMZ is to use Zero-Trust (ZTA) which requires identity verification of a user and/or system regardless whether the user is outside the internal private network or outside the internal private network. If such malicious content is detected within a communication, the system can isolate or otherwise prevent the communication from being forwarded from the cloud-based DMZ to its intended destination.

Communications to/from the DMZ can also be analyzed by the DMZ equipment and used to predict patterns in future communications (such as frequency or volume), predict malicious or approved content based on the source and/or destination of the communication, the time of a communication (e.g., for a particular piece of OT equipment, receiving a communication in the middle of the night may indicate malicious intent), a number of operators or other human workers near the OT, etc. This analysis can be executed by the computing platform executing the DMZ, a separate enterprise data analytics platform, and/or by a third-party platform. As an example of such an analysis, if the OT environment is an engine management system on board a vessel, the system can generate a real time model (often referred to as a “digital twin”) of how that engine or engines are supposed to perform. Using the predictive analytics, the system can use AI (Artificial Intelligence) or machine learning to predict when a failure might happen. For example, the system can use previous communications received over a period of time (and the results associated with those communications) as training data for a neural network, then use the resulting neural network to analyze current communications. For example, the communication can be related to various parameters of an engine or other OT equipment, such as temperature, pressure, rotation speed, etc. Continuing with the engine management example, the system may use the communications to determine at which RPM the engine produces the best power, the best fuel economy, the highest speed, etc. As another example, the system can analyze data to enable better decision-making by the system.

In addition to controlling communications between the IT systems and the OT systems, the DMZ can control communications to/from an enterprise network (for example, the network associated with a company or service managing the IT and OT systems). The enterprise network can, for example, have sub-portions assigned to different departments, different field offices, different users, etc. In such a configuration, the DMZ can utilize firewalls when receiving communications from the enterprise network, from the IT systems, and from the OT systems. In some configurations, the system can use specific null routes to eliminate the possibility of reaching certain network segments, resulting in isolated segments on the devices and in the DMZ. After analysis and approval of the communications by processors and other equipment within the DMZ, systems controlling data flow through the DMZ can then forward the communications to their intended targets.

In some configurations, the analysis of the communications to/from the DMZ can be performed using a third-party enterprise computing platform, such as services provided by, or hosted within AMAZON WEB SERVICES (AWS) or AZURE. In such configurations, devices within the DMZ (e.g., one or more DMZ processors, memory, firewalls, and/or other computing devices) can send communications to the third-party enterprise computing platform for analysis, then receive approval (or rejection) of the communication based on the analysis. The amount of computing processing power required by the enterprise data platform can then increase/decrease depending upon the volume and types of communications being analyzed. The third-party enterprise computing platform can also be used to perform communication or data analytics through the use of AI and/or machine learning.

The communications between the module-equipped OT/IT systems and the DMZ can rely on a zero-trust Q-SEC (Quantum Secure) private tunnel. A private tunnel refers to an encrypted connection between an OT/IT device and the servers of the DMZ. A “zero-trust” system is a cybersecurity policy which is applied based on context established through least-privileged access controls and strict identification and authentication-not assumed trust. A zero-trust approach treats all communications, even if the communication is from a trusted zone or internal source, as unauthorized. Zero-trust policies verify access requests and rights based on context, including user identity, device, location, type of content, and the application or OT equipment to which communications are directed. In systems where all assets participate in the zero-trust architecture, users or systems can connect directly to the apps and resources they need, however they may never be given access to the entire networks. In addition, these direct user-to-app and app-to-app connections can reduce the risk of compromised devices from further compromising other resources. For example, the system can be “hypervised,” meaning that multiple virtual machines can be deployed to receive and analyze different data communications and/or perform different functions, making relevant decisions prior to entering, and/or within the cloud-based DMZ. Each virtual machine can be associated with distinct identification information, such that communications from different OT equipment can be directed to specific virtual machines, virtually isolating systems from each other and reducing the ability to intercept communications.

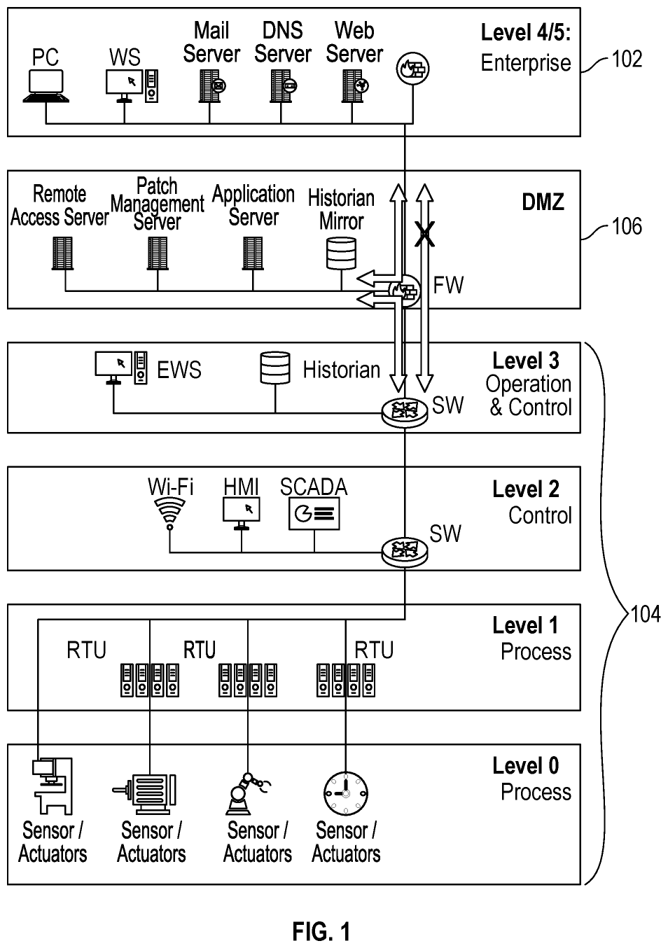

FIG. 1 illustrates an example of an enterprise architecture using the Purdue model. In this example, communications between the IT operations (levels 4 and 5) 102, and the OT operations (levels 0-3) are moderated by a DMZ 106 such that no direct communication is allowed between IT operations (levels 4 and 5) 102 and the OT operations (levels 0 to 3) 104. The DMZ 106 as illustrated requires DMZ 106 equipment/infrastructure (e.g., DMZ-specific processors) at each location where OT equipment 104 may be located, as the DMZ equipment/processors within the DMZ 106 analyze communications before those communications are delivered to the OT equipment 104.

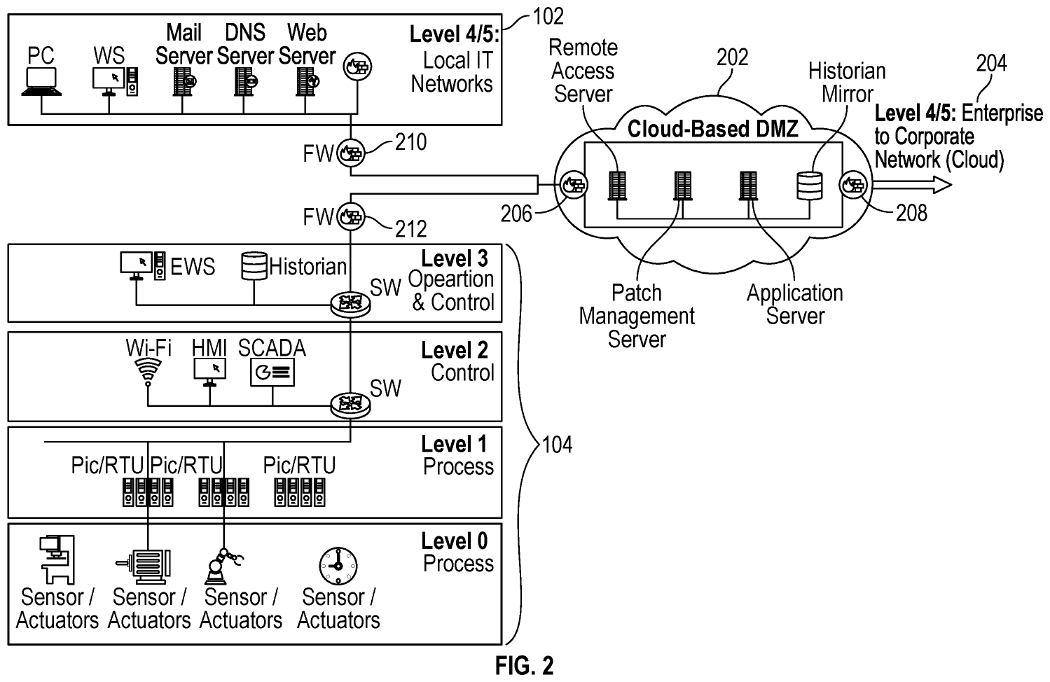

FIG. 2 illustrates an example of a hybrid variation on the Purdue reference architecture. In this example, the IT levels (levels 4/5) 102, and the OT levels (levels 0-3) remain identical to those in FIG. 1. However, in this example the DMZ 202 has been moved to the cloud (e.g., remotely located computing systems or servers, which may or may not be managed by third parties). The cloud-based DMZ 202 is connected to the IT layers 102 through a firewall 210, and to the OT layers 104 through a separate firewall 212. Systems (e.g., additional processors, memory, and/or other computing components) within the cloud-based DMZ 202 can also be used to moderate communications with one or more corporate networks 204, which may also be located in the cloud or may be contained on identifiable, known servers and computing systems in physical facilities. To connect the cloud-based DMZ 202 with the corporate network(s) 204, the system can use yet another firewall 206. Routing decisions can be made by one or more DMZ processors based on business needs for the data. Communications can be secured/encrypted (using PQE) between the firewalls 210 and 206, as well as between 212 and 206. Please note that it is not the firewall that encrypts the data; it is simply a network gateway/conduit through which authorized communications can flow.

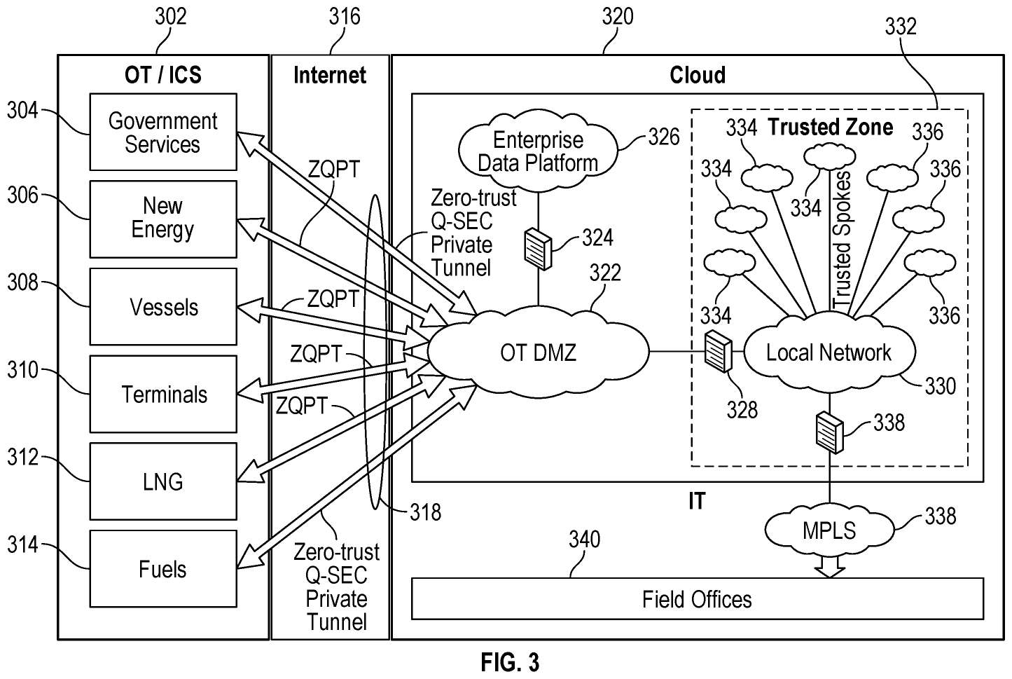

FIG. 3 illustrates an example of an enterprise architecture that incorporates a cloud-based operational technology DMZ 322, where the DMZ 322 can contain additional processors, memory, and/or other computing components, allowing for data processing, analysis, screening, etc. within the DMZ 322. In this example, there are multiple different types of OT and ICS (Industrial Control Systems) equipment 302 which may, for purposes of this disclosure, be considered a type of OT equipment (such as Terminals 310 and Government Services 304). Specific types of OT equipment illustrated include new energy services 306 (such as wind and solar energy), vessels 308 (such as maritime shipping boats or ships, trains, semi-trucks), Liquified Natural Gas (LNG) pumps 312 or refining equipment, and fuel 314 pumps or refining equipment. The data from each of these pieces of OT 302 can be communicated through the Internet 316 via a Zero-trust Q-Sec private tunnel 318 to the cloud-based OT DMZ 322. A Zero-trust Q-Sec private tunnels 318 can be a methodology in which access to equipment is tightly controlled with regards to what data can traverse the tunnel. Users or systems on both ends of the tunnel may require positive identification before being authorized to communicate. Access can be controlled with network access control policies and/or authentication, where applicable.

The communications and data received from the OT/ICS 302 equipment at the cloud-based OT DMZ 322 can be analyzed by an enterprise data platform 326, that may be housed (for example) within AWS or AZURE (or any other enterprise data platform 326), with the data passing through a firewall 324 to reach the corporate network. The communications and data can, after analysis and/or approval, be forwarded from the cloud-based OT DMZ 322 to a local network 330 (again passing through a firewall 328). From that local network 330, the communications/data can be made available to specific sub-networks 334, 336, departments, or other computing systems which are within a “Trusted Zone” 332 (meaning that they are known entities with restricted access). The communications/data can also be made available to field offices 340 or other remote locations, with the communications/data again passing through a firewall 338 and/or a MPLS (Multi-Protocol Label Switching) network 338.

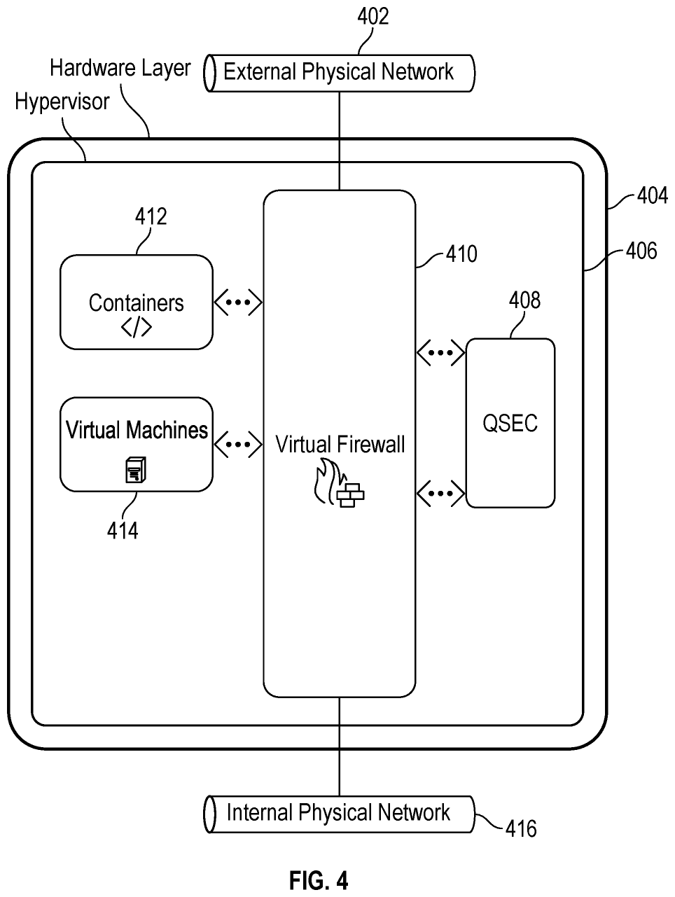

FIG. 4 illustrates an example of a modular component 404 which can be added to operational technology to enable secure communications. This component represents the physical hardware platform on which the hypervisor software runs containing the modular software components. In this example, the modular component 404 connects an internal physical network 416 to an external physical network 402, using a combination of a virtual firewall 410, virtual machines 414, and containers 412. These virtual machines 414 and/or containers 412 can be used to evaluate the malicious or non-malicious nature of data prior to forwarding the data between the internal physical network 416 and/or the external physical network 402.

The quantum security (QSEC) module 408 can be the above-mentioned PQE module, where the communications between the internal physical network 416 and the external physical network 402 are encrypted/decrypted with post-quantum encryption (PQE), mitigating opportunities for the communications to be decrypted or compromised by outside parties. The modular component 404 includes a hypervisor 406, meaning that the module 404 can include multiple different virtual machines 414, each of which are executing different applications or algorithms. The virtual machines 414 can communicate with the quantum security module 408 through the firewall 410 to enable secure communication between the internal physical network 416 and the external physical network 402 via the modular component 404. Note that in some configurations every aspect of the illustrated modular component 404 and hypervisor 406 could be virtualized, including the hardware layer as well as the internal and external networks.

Non-limiting examples of modules 404 can include one or more of:

A passive scanner, which can capture network traffic, build a baseline of activity (may include offsite Artificial Intelligence (AI)/Machine Learning (ML), and identify devices based on activity and unique artifacts. One a baseline is established, the passive scanner can generate alerts based on detection of new/unusual activity and/or new devices. The passive scanner can be a separate hardware device or can be software executed by one or more processors within the module.

An inventory scanner, which can: produce a hardware inventory based on passive monitoring, produce a hardware inventory based on active scanning (e.g., manually initiated, or actively scanning by sending data across the network to probe or interrogate systems), produce a software inventory based on passive monitoring, and/or produce software inventory based on active scanning. The inventory scanner can be a separate hardware device, can be software executed by one or more processors within the module 404, and/or can be combined with the passive scanner.

A vulnerability scanner, which can evaluate system communications or responses against known criteria stored in a vulnerability database and determine the presence or absence of a vulnerability. The vulnerability database can be stored within the module on a non-transitory computer-readable storage medium, or may be located externally to the module 404. A vulnerability scanner may have the ability to execute one or more different types of scans, such as a passive scan (where the scanner attempts to identify potentially vulnerable systems based on activity), an active scan (where the scanner attempts to identify potentially vulnerable systems based on open ports or responses to probing activity), and/or a credentialed scan (where the scanner is able to connect to the remote device and evaluate vulnerabilities).

A lightweight IDS/IPS (Intrusion Detection System/Intrusion Prevention System), which can monitor network activity, compare communication activity to stored patterns or signatures within a malicious activity database, generate alerts on suspicious activity, and/or block activity (e.g., via NAC (Network Access Control)).

An ICS (Industrial Control System) protocol interpreter, which can ingest and convert the ICS protocols into human-readable formats, build a baseline of activities (e.g., using offsite AI/ML), and/or generate alerts based on baseline deviations.

A syslog collector/log forwarder, which can collect and forward system logs. The system logs may be in a Syslog, NetFlow, or system-specific format.

A honeypot, which can provide target(s) that may look appealing to an attacker, and generate alerts upon detecting suspicious activity.

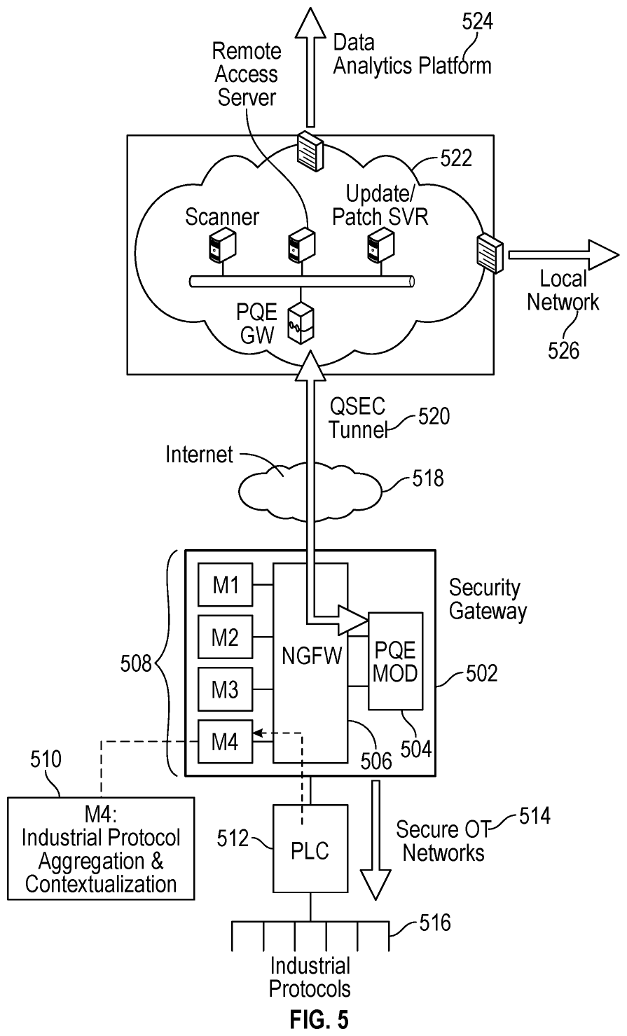

FIG. 5 illustrates an example of data flow for a deployed component module. In this example, the security gateway 502 is the modular component 404 illustrated in FIG. 4. The security gateway 502 contains a PQE module 504, which is connected to a Next-Generation Firewall (NGFW) 506. Traditional firewalls typically only inspect and control traffic at the network layer. A next-generation firewall (NGFW) is a type of firewall that is able to inspect and control network traffic at layers 2-7 of the standard OSI model, in addition to the standard packet filtering capabilities of a traditional firewall. This allows for more advanced security features such as intrusion prevention, application control, and user identity-based policies. The PQE module 504 corresponds to the quantum security module 408 shown in FIG. 4. The NGFW 506 operates as a firewall between the PQE module 504 and a number of modules (e.g., M1, M2, M3 and M4) 508. Module (M4) 510 executes industrial protocol aggregation and contextualization 510. The security gateway 502 operates as a gatekeeper between OT networks 514, which are reached using a programmable logic controller (PLC) 512, where the PLC can use industrial protocols 516 to communicate with the OT equipment according to OT system requirements with which communications are being shared. The security gateway 502 can also send/receive communications with a DMZ 522 (illustrated here as cloud-based, though in other configurations the DMZ may not be cloud-based) via a quantum secure (QSEC) tunnel 520 across the Internet 518. The DMZ 522 can contain additional processors, memory, and/or other computing components, such that the DMZ equipment can perform additional analysis, computations, data screening, and/or other processing on data traversing the DMZ 522. Using this DMZ equipment, the DMZ 522 communicates with the PQE module 504 via the quantum secure (QSEC) tunnel 520 thus enabling quantum secure communication between the DMZ 522 and the security gateway 502 across the internet 518. Likewise, the DMZ 522 can forward the communications to a data analytics platform 524, such that the communications can be analyzed using the data analytics platform 524. The communications can also be transmitted/received from a local network 526, such as a company specific intranet or other restricted-access network.

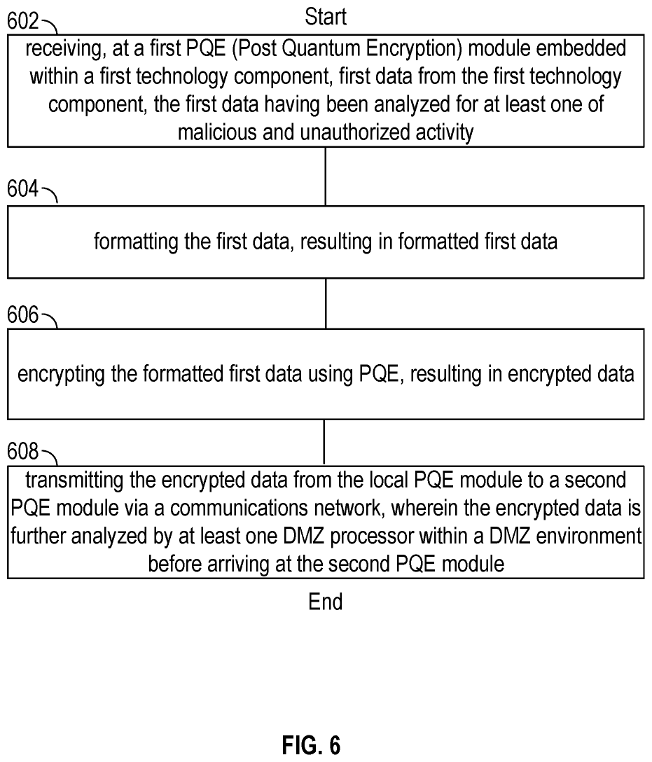

FIG. 6 illustrates an example method embodiment. As illustrated, a method as described herein can include: receiving, at a first PQE (Post Quantum Encryption) module embedded within a first technology component, first data from the first technology component, the first data having been analyzed for at least one of malicious and unauthorized activity (602). The method can continue with formatting the first authorized data, resulting in formatted first data (604). The method continues by encrypting the formatted first data using PQE, resulting in encrypted data (606) and transmitting the encrypted data from the first PQE module to a second PQE module via a communications network, wherein the encrypted data is further analyzed by at least one DMZ processor within a DMZ environment before arriving at the second PQE module (08).

In some configurations, the DMZ environment is cloud-based and hypervised, such that the at least one DMZ processor supports execution of multiple virtual machines.

In some configurations, the DMZ environment is physical and hypervised, such that the at least one DMZ processor supports execution of multiple virtual machines.

In some configurations, the encrypted data is routed through the communications network using a post-quantum encryption tunnel.

In some configurations, the encrypted data is routed through the communications network using a zero-trust quantum-security private tunnel.

In some configurations, the first technological component comprises at least one of: fuel operational equipment, navigation vessel equipment, and liquid navigation equipment.

In some configurations, at least a portion of the encrypted data is routed from the DMZ environment by the at least one DMZ processor to a second aggregation and analysis platform prior to the encrypted data being forwarded to the second PQE module.

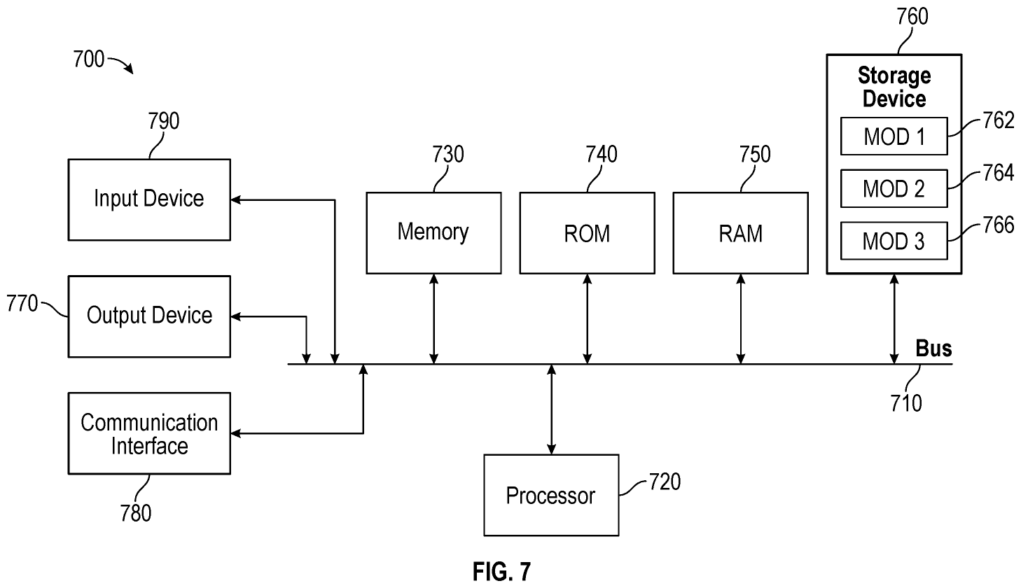

With reference to FIG. 7, an exemplary system includes a general-purpose computing device 700, including a processing unit (CPU or processor) 720 and a system bus 710 that couples various system components including the system memory 730 such as read-only memory (ROM) 740 and random-access memory (RAM) 750 to the processor 720. The system 700 can include a cache of high-speed memory connected directly with, in close proximity to, or integrated as part of the processor 720. The system 700 copies data from the memory 730 and/or the storage device 760 to the cache for quick access by the processor 720. In this way, the cache provides a performance boost that avoids processor 720 delays while waiting for data. These and other modules can control or be configured to control the processor 720 to perform various actions. Other system memory 730 may be available for use as well. The memory 730 can include multiple different types of memory with different performance characteristics. It can be appreciated that the disclosure may operate on a computing device 700 with more than one processor 720 or on a group or cluster of computing devices networked together to provide greater processing capability. The processor 720 can include any general-purpose processor and a hardware module or software module, such as module 1 762, module 2 764, and module 3 766 stored in storage device 760, configured to control the processor 720 as well as a special-purpose processor where software instructions are incorporated into the actual processor design. The processor 720 may essentially be a completely self-contained computing system, containing multiple cores or processors, a bus, memory controller, cache, etc. A multi-core processor may be symmetric or asymmetric.

The system bus 710 may be any of several types of bus structures including a memory bus or memory controller, a peripheral bus, and a local bus using any of a variety of bus architectures. A basic input/output (BIOS) stored in ROM 740 or the like, may provide the basic routine that helps to transfer information between elements within the computing device 700, such as during start-up. The computing device 700 further includes storage devices 760 such as a hard disk drive, a magnetic disk drive, an optical disk drive, tape drive or the like. The storage device 760 can include software modules 762, 764, 766 for controlling the processor 720. Other hardware or software modules are contemplated. The storage device 760 is connected to the system bus 710 by a drive interface. The drives and the associated computer-readable storage media provide nonvolatile storage of computer-readable instructions, data structures, program modules and other data for the computing device 700. In one aspect, a hardware module that performs a particular function includes the software component stored in a tangible computer-readable storage medium in connection with the necessary hardware components, such as the processor 720, bus 710, display 770, and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the device 700 is a small, handheld computing device, a desktop computer, or a computer server.

Although the exemplary embodiment described herein employs the hard disk 760, other types of computer-readable media which can store data that are accessible by a computer, such as magnetic cassettes, flash memory cards, digital versatile disks, cartridges, random access memories (RAMs) 750, and read-only memory (ROM) 740, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 700, an input device 790 represents any number of input mechanisms, such as a microphone for speech, a touch-sensitive screen for gesture or graphical input, keyboard, mouse, motion input, speech and so forth. An output device 770 can also be one or more of a number of output mechanisms known to those of skill in the art. In some instances, multimodal systems enable a user to provide multiple types of input to communicate with the computing device 700. The communications interface 780 generally governs and manages the user input and system output. There is no restriction on operating on any particular hardware arrangement and therefore the basic features here may easily be substituted for improved hardware or firmware arrangements as they are developed.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

Further aspects of the present disclosure are provided by the subject matter of the following clauses.

A system, comprising: a physical computing platform; at least one local networked environment, the at least one local networked environment comprising at least one of a local operational technology (OT) environment and a local informational technology (IT) environment, wherein the at least one of the local OT environment comprises at least one OT technology component and the local IT environment comprises at least one IT technology component; at least one remote networked environment, the at least one remote networked environment comprising at least one of a remote OT environment and a remote IT environment, the at least one of the remote OT environment and the remote IT environment configured to perform at least one of receiving data, transmitting data, and exchanging data; and a communications network connecting the at least one local networked environment to the at least remote networked environment, wherein communications between the at least one local networked environment and the at least one remote networked environment are routed over the communications network using post-quantum encryption; and wherein the physical computing platform reviews the communications for at least one of malicious and unauthorized activity prior to forwarding approved communications.

The system of any preceding clause, wherein the physical computing platform is hypervised, such that the physical computing platform supports execution of multiple virtual machines.

The system of any preceding clause, further comprising: at least one post-quantum encryption module, wherein: the at least one post-quantum encryption module is in communication with at least one of the IT technology component and the OT technology component; and the at least one post-quantum encryption module encrypts communications, resulting in encrypted communications which are resistant to unauthorized quantum decryption.

The system of any preceding clause, wherein the encrypted communications are routed through the physical computing platform using a post-quantum encryption tunnel.

The system of any preceding clause, wherein the encrypted communications are routed through the physical computing platform using a zero-trust quantum-security private tunnel.

The system of any preceding clause, wherein the at least one OT technological component comprises at least one of: fuel operational equipment, navigation vessel equipment, and liquid navigation equipment.

The system of any preceding clause, wherein at least a portion of the communications are routed from the physical computing platform to an enterprise data analytics platform.

The system of any preceding clause, wherein the enterprise data analytics platform executes a machine learning algorithm on the at least a portion of the communications, resulting in identification of malicious communications within the communications.

A method comprising: receiving an encrypted communication at a remote computing platform networked between at least one local informational technology (IT) network and at least one local operational technology (OT) network, the at least one local OT network comprising at least one local technology component, the encrypted communication having been encrypted using post-quantum encryption; copying, at the remote computing platform, the encrypted communication, resulting in a copy of the encrypted communication; decrypting, using the post-quantum encryption, the copy of the encrypted communication, resulting in a decrypted communication; reviewing, via at least one processor of the remote computing platform executing a malware detection algorithm, the decrypted communication for maliciousness, resulting in an approval of the encrypted communication; upon identifying the approval, transmitting the encrypted communication from the remote computing platform to a destination, the destination being within the at least one local IT network or the at least one OT technology component.

The method of any preceding clause, wherein the remote computing platform is cloud-based and hypervised, such that the remote computing platform supports execution of multiple virtual machines.

The method of any preceding clause, wherein the remote computing platform is physical and hypervised, such that the remote computing platform supports execution of multiple virtual machines.

The method of any preceding clause, wherein: the encrypted communication is encrypted using a post-quantum encryption module, such that the encrypted communication is resistant to unauthorized quantum decryption.

The method of any preceding clause, wherein the encrypted communication is routed between the at least one local IT network and at least one local OT network and the remote computing platform using a post-quantum encryption tunnel.

The method of any preceding clause, wherein the encrypted communication is routed between the at least one local IT network and at least one local OT network and the remote computing platform using a zero-trust quantum-security private tunnel.

The method of any preceding clause, wherein the at least one OT technological component comprises at least one of: fuel operational equipment, navigation vessel equipment, and liquid navigation equipment.

The method of any preceding clause, wherein at least a portion of the decrypted communication is routed from the remote computing platform to a remote aggregation and analysis platform.

The method of any preceding clause, wherein the remote aggregation and analysis platform executes a machine learning algorithm on the at least a portion of the decrypted communication, resulting in identification of malicious communications within the encrypted communication.

The method of any preceding clause, wherein the remote aggregation and analysis platform executes a machine learning algorithm on the at least a portion of the decrypted communication, resulting in optimized business decisions.

A non-transitory computer-readable storage medium having instructions stored which, when executed by at least one processor, cause the processor to perform operations comprising: receiving, at a cloud-based computing platform networked between at least one local informational technology (IT) network and at least one operational technology (OT) component and information technology (IT) component, an encrypted communication, the encrypted communication having been encrypted using post-quantum encryption; copying, at the cloud-based computing platform, the communication, resulting in a copy of the communication; decrypting, using the post-quantum encryption, the copy of the communication, resulting in a decrypted communication; reviewing, via executing a malware detection algorithm, the decrypted communication for maliciousness, resulting in an approval of the encrypted communication; upon identifying the approval, transmitting the encrypted communication from the cloud-based computing platform to a destination, the destination being within the at least one local IT network or the at least one operational technology component.

The non-transitory computer-readable storage medium of any preceding clause, wherein: the encrypted communication is encrypted using a post-quantum encryption module, such that the encrypted communication is resistant to unauthorized quantum decryption.

A system, comprising: a first technology environment comprising at least one first technology component, the at least one first technology component comprising a first Post-Quantum Encryption (PQE) module; a second technology environment separated from the first technology environment by a communications network, the second technology environment comprising at least one second technology component, the at least one second technology component comprising a second PQE module; and a demilitarized zone (DMZ) environment having at least one DMZ processor, wherein the first technology environment, the second technology environment, and the DMZ environment are networked together across the communications network such that communications between the first technology environment and the second technology environment pass through the DMZ environment; and wherein the first PQE module and the second PQE module each perform at least one of transmitting and receiving of the communications between the first technology environment and the second technology environment, the communications being encrypted using PQE algorithms.

The system of any preceding clause, wherein the first technology environment further comprises at least one first environment additional module; wherein the second technology environment further comprises at least one second environment additional module; and wherein during transmission from the first technology environment to the second technology environment: the at least one first environment additional module reviews data received from the at least one first technology component for at least one of malicious and unauthorized activity, resulting in first authorized data; the first PQE module formats and encrypts the first authorized data using PQE, resulting in an encrypted transmission; the encrypted transmission is routed over the communications network from the first technology environment to the second technology environment through the DMZ environment using the at least one DMZ processor; the second PQE module receives the encrypted transmission; the second PQE module decrypts the encrypted transmission using PQE, resulted in decrypted data; the at least one second environment additional module analyzes the decrypted data for at least one of malicious and unauthorized activity, resulting in second authorized data; and the second PQE module forwards the second authorized data to the at least one second technology component.

The system of any preceding clause, wherein the at least one DMZ processor decrypts and analyzes the encrypted transmission for at least one of malicious and unauthorized activity prior to forwarding the encrypted transmission to the second PQE module.

The system of any preceding clause, wherein the at least one first technology component comprises an Operational Technology (OT) component.

The system of any preceding clause, wherein the at least first technological component comprises at least one of: fuel operational equipment, navigation vessel equipment, and liquid navigation equipment.

The system of any preceding clause, wherein the at least one second technology component comprises an Information Technology (IT) component.

The system of any preceding clause, wherein the DMZ environment is hypervised, such that the at least one DMZ processor supports execution of multiple virtual machines.

The system of any preceding clause, wherein the communications are routed through the DMZ environment by the at least one DMZ processor using a post-quantum encryption tunnel.

The system of any preceding clause, wherein the communications are routed through the DMZ environment using a zero-trust quantum-security private tunnel.

The system of any preceding clause, wherein at least a portion of the communications are routed from the DMZ environment by the at least one DMZ processor to an enterprise data analytics platform.

The system of any preceding clause, wherein the enterprise data analytics platform executes a machine learning algorithm on the at least a portion of the communications, resulting in identification of malicious communications within the communications.

The system of any preceding clause, wherein the DMZ environment is cloud-based.

A method comprising: receiving, at a first PQE (Post Quantum Encryption) module embedded within a first technology component, first data from the first technology component, the first data having been analyzed for at least one of malicious and unauthorized activity; formatting the first data, resulting in formatted first data; encrypting the formatted first data using PQE, resulting in encrypted data; and transmitting the encrypted data from the first PQE module to a second PQE module via a communications network, wherein the encrypted data is further analyzed by at least one DMZ processor within a DMZ environment before arriving at the second PQE module.

The method of any preceding clause, wherein the DMZ environment is cloud-based and hypervised, such that the at least one DMZ processor supports execution of multiple virtual machines.

The method of any preceding clause, wherein the DMZ environment is physical and hypervised, such that the at least one DMZ processor supports execution of multiple virtual machines.

The method of any preceding clause, wherein the encrypted data is routed through the communications network using a post-quantum encryption tunnel.

The method of any preceding clause, wherein the encrypted data is routed through the communications network using a zero-trust quantum-security private tunnel.

The method of any preceding clause, wherein the first technological component comprises at least one of: fuel operational equipment, navigation vessel equipment, and liquid navigation equipment.

The method of any preceding clause, wherein at least a portion of the encrypted data is routed from the DMZ environment to a second aggregation and analysis platform prior to the encrypted data being forwarded to the second PQE module.

A non-transitory computer-readable storage medium having instructions stored which, when executed by at least one processor, cause the processor to perform operations comprising: receiving, at a first PQE (Post Quantum Encryption) module embedded within a first technology component, first data from the first technology component, the first data having been analyzed for at least one of malicious and unauthorized activity; formatting the first authorized data, resulting in formatted first data; encrypting the formatted first data using PQE, resulting in encrypted data; and transmitting the encrypted data from the first PQE module to a second PQE module via a communications network, wherein the encrypted data is further analyzed by a DMZ environment before arriving at the second PQE module.

We claim:

1. A system, comprising:
a first technology environment comprising at least one first technology component, the at least one first technology component comprising a first Post-Quantum Encryption (PQE) module;
a second technology environment separated from the first technology environment by a communications network, the second technology environment comprising at least one second technology component, the at least one second technology component comprising a second PQE module; and
a demilitarized zone (DMZ) environment having at least one DMZ processor,
wherein the first technology environment, the second technology environment, and the DMZ environment are networked together across the communications network such that communications between the first technology environment and the second technology environment pass through the DMZ environment; and
wherein the first PQE module and the second PQE module each perform at least one of transmitting and receiving of the communications between the first technology environment and the second technology environment, the communications being encrypted using PQE algorithms.

2. The system of claim 1, wherein the first technology environment further comprises at least one first environment additional module;
wherein the second technology environment further comprises at least one second environment additional module; and
wherein during transmission from the first technology environment to the second technology environment:
the at least one first environment additional module reviews data received from the at least one first technology component for at least one of malicious and unauthorized activity, resulting in first authorized data;
the first PQE module formats and encrypts the first authorized data using PQE, resulting in an encrypted transmission;
the encrypted transmission is routed over the communications network from the first technology environment to the second technology environment through the DMZ environment;
the second PQE module receives the encrypted transmission;
the second PQE module decrypts the encrypted transmission using PQE, resulted in decrypted data;
the at least one second environment additional module analyzes the decrypted data for at least one of malicious and unauthorized activity, resulting in second authorized data; and
the second PQE module forwards the second authorized data to the at least one second technology component.

3. The system of claim 2, wherein the at least one DMZ processor within the DMZ environment decrypts and analyzes the encrypted transmission for at least one of malicious and unauthorized activity prior to forwarding the encrypted transmission to the second PQE module.

4. The system of claim 1, wherein the at least one first technology component comprises an Operational Technology (OT) component.

5. The system of claim 4, wherein the at least one first technological component comprises at least one of: fuel operational equipment, navigation vessel equipment, and liquid navigation equipment.

6. The system of claim 1, wherein the at least one second technology component comprises an Information Technology (IT) component.

7. The system of claim 1, wherein the DMZ environment is hypervised, such that the DMZ environment supports execution of multiple virtual machines.

8. The system of claim 1, wherein the communications are routed through the DMZ environment by the at least one DMZ processor using a post-quantum encryption tunnel.

9. The system of claim 1, wherein the communications are routed through the DMZ environment using a zero-trust quantum-security private tunnel.

10. The system of claim 1, wherein at least a portion of the communications are routed from the DMZ environment to an enterprise data analytics platform.

11. The system of claim 10, wherein the enterprise data analytics platform executes a machine learning algorithm on the at least a portion of the communications, resulting in identification of malicious communications within the communications.

12. The system of claim 1, wherein the DMZ environment is cloud-based.

13. A method comprising:
receiving, at a first PQE (Post Quantum Encryption) module embedded within a first technology component, first data from the first technology component, the first data having been analyzed for at least one of malicious and unauthorized activity;
formatting the first data, resulting in formatted first data;
encrypting the formatted first data using PQE, resulting in encrypted data; and
transmitting the encrypted data from the first PQE module to a second PQE module via a communications network, wherein the encrypted data is further analyzed by at least one DMZ processor within a DMZ environment before arriving at the second PQE module.

14. The method of claim 13, wherein the DMZ environment is cloud-based and hypervised, such that the at least one DMZ processor supports execution of multiple virtual machines.

15. The method of claim 13, wherein the DMZ environment is physical and hypervised, such that the at least one DMZ processor supports execution of multiple virtual machines.

16. The method of claim 13, wherein the encrypted data is routed through the communications network using a post-quantum encryption tunnel.

17. The method of claim 13, wherein the encrypted data is routed through the communications network using a zero-trust quantum-security private tunnel.

18. The method of claim 13, wherein the first technological component comprises at least one of: fuel operational equipment, navigation vessel equipment, and liquid navigation equipment.

19. The method of claim 13, wherein at least a portion of the encrypted data is routed from the DMZ environment to a second aggregation and analysis platform prior to the encrypted data being forwarded to the second PQE module.

20. A non-transitory computer-readable storage medium having instructions stored which, when executed by at least one processor, cause the processor to perform operations comprising:
receiving, at a first PQE (Post Quantum Encryption) module embedded within a first technology component, first data from the first technology component, the first data having been analyzed for at least one of malicious and unauthorized activity;
formatting the first data, resulting in formatted first data;
encrypting the formatted first data using PQE, resulting in encrypted data; and
transmitting the encrypted data from the first PQE module to a second PQE module via a communications network, wherein the encrypted data is further analyzed by at least one DMZ processor of a DMZ environment before arriving at the second PQE module.
